(19) United States
(12) Patent Application Publication
(10) Pub. No.: US 2023/0351103 A1
(43) Pub. Date: Nov. 2, 2023

(54) METHODS AND SYSTEMS FOR AUTOMATICALLY VALIDATING FILLED-OUT APPLICATION FORMS AGAINST ONE OR MORE VERIFICATION DOCUMENTS

(71) Applicant: XEROX CORPORATION, Norwalk, CT (US)

(72) Inventors: Ashok Jason Vedaraj, Chennai (IN); Ganachari Subrahmanyam, Andhra Pradesh (IN); Zakirahmed Shaik, Nellore (IN); Sandhya Srinivasan, Chennai (IN)

(73) Assignee: XEROX CORPORATION, Norwalk, CT (US)

(21) Appl. No.: 17/660,880

(22) Filed: Apr. 27, 2022

(51) Int. Cl. G06F 40/174; G06F 21/64

(52) U.S. Cl. CPC G06F 40/174; G06F 21/64

(57) ABSTRACT

The disclosure discloses methods and systems for automatically validating content of filled-out application forms against one or more corresponding verification documents. The filled-out application form including pre-defined fields and filled-out content, is received at an automatic feeder. Then, one or more corresponding verification documents are received at pre-defined markings on a platen. The verification documents include pre-defined fields and pre-verified content. Thereafter, the filled-out application form and the verification documents are scanned. The scanned filled-out application form and the scanned verification documents are analyzed to extract the filled-out content from the scanned filled-out application form and the pre-verified content from the scanned verification documents. Post extraction, the filled-out content is matched with the pre-verified content and accordingly errors are highlighted in the scanned filled-out application form. This way, the filled-out application forms are validated.

### TECHNICAL FIELD

The present disclosure relates to the field of application forms. More specifically, the disclosure relates to methods and systems for automatically validating filled-out application forms against one or more verification documents.

### BACKGROUND

Organizations such as banks, colleges, schools, recruitment agencies, passport offices, visa offices require application forms for different purposes, e.g., opening a bank account, applying for a credit/debit card, applying for a passport/visa, getting admissions in schools/colleges, or the like. Applicants fill-out these application forms and submit these to the concerned organization. Once submitted, these forms are required to be validated against various verification documents to ensure that details/information included in the application forms is correct. Various examples include permanent account number (PAN) card, driving license, passport, or the like.

Currently, an applicant fills-out an application form and submits the filled-out application form and corresponding one or more verification documents to the organization. Post submission, an employee of the organization manually verifies the filled-out application form by manually comparing details filled-out by the applicant with details of the verification documents. For example, the employee cross-checks each letter/digit/symbol, one at a time, from the verification documents as provided. Here, manually validating these forms leads to long queues, dissatisfied customers, and frustrated employees of organization. Any task done by hand is prone to errors and mistakes.

Moreover, organizations receive a huge number of application forms daily and validating such a large number manually is a very time-consuming, tedious, and inefficient in nature. A bank, for instance, witnesses hundreds of customers submitting forms on a daily basis and manually validating each form is an effort-intensive task. Sometimes employees who are verifying these forms, are not true to the concerned organization and may try to wrongfully pass the validation of particular forms for personal benefits and thereby poses risk for the organization. In this view, there is a need for error-free, unbiased, efficient, and convenient methods and systems for validating filled-out applications forms.

### SUMMARY

According to aspects illustrated herein, there is a method for automatically validating filled-out application forms against one or more verification documents, where the method is performed at a multi-function device. The method includes receiving the filled-out application form at an automatic feeder of the multi-function device. The filled-out application form includes one or more pre-defined fields and filled-out content. Then, one or more verification documents are received at pre-defined markings on a platen of the multi-function device. The one or more verification documents include one or more pre-defined fields and pre-verified content. Thereafter, the filled-out application form and the one or more verification documents scanned. Post scanning, the filled-out content is extracted from the scanned filled-out application form and the pre-verified content is extracted from the one or more scanned verification documents. Post extraction, the filled-out content extracted from the scanned filled-out application form is matched with the pre-verified content extracted from the one or more scanned verification documents. Finally, based on matching, unmatched filled-out content is highlighted in the scanned filled-out application form.

According to further aspects illustrated herein, a method for automatically validating filled-out application forms against one or more verification documents is disclosed, where the method is performed at a multi-function device. The method includes scanning a filled-out application form and one or more verification documents required corresponding to the filled-out application form. The filled-out application form includes one or more pre-defined fields and filled-out content, and each verification document includes one or more pre-defined fields and pre-verified content. Post scanning, the filled-out content from the scanned filled-out application form is matched with the pre-verified content of each scanned verification document. Finally, based on matching, unmatched filled-out content is highlighted in the scanned filled-out application form.

According to furthermore aspects illustrated herein, a multi-function device for automatically validating content of a filled-out application form against one or more verification documents is disclosed. The multi-function device includes an automatic feeder for receiving a filled-out application form, which includes one or more pre-defined fields and filled-out content. The multi-function device also includes a platen having one or more pre-defined markings for receiving one or more verification documents and each verification document includes one or more pre-defined fields and pre-verified content. A scanner is for scanning the filled-out application form and the one or more verification documents. Further, the multi-function device includes a validation module for: extracting the filled-out content from the scanned filled-out application form and the pre-verified content from the one or more scanned verification documents; matching the filled-out content extracted from the scanned filled-out application form with pre-verified content extracted from the one or more scanned verification documents; and highlighting one or more errors in the scanned filled-out application form based on the matching. The multi-function device additionally includes a user interface for displaying the highlighted one or more errors in the scanned filled-out application form.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIGS. 2A, 2B, 2C-2D and 2E-2F show exemplary snapshots of application forms, in accordance with an embodiment of the present disclosure.

FIGS. 3A and 3B show exemplary snapshots of verification documents, in accordance with an embodiment of the present disclosure.

FIG. 4 is a block diagram illustrating various components of a multi-function device, in accordance with an embodiment of the present disclosure.

FIG. 5 shows a multi-function device including a platen with one or more pre-defined markings for receiving one or more verification documents.

FIG. 6 is a method flowchart for automatically validating filled-out application forms against corresponding one or more verification documents, in accordance with an embodiment of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device or a combination of multiple devices, to perform one or more functions such as, but not limited to, printing, imaging, scanning, and so forth. The multi-function device may include software, hardware, firmware, or a combination thereof. In the context of the current disclosure, the multi-function device automatically validates filled-out application forms against corresponding one or more verification documents. The multi-function device includes a platen and an automatic feeder, but the multi-function device may include other components for implementing the current disclosure.

The term “application forms” refer to various forms required for different purposes in various organizations such as banks, colleges, schools, passport offices, etc. For example, the application forms may be needed for opening a bank account, getting admission to schools/colleges, applying for a passport, applying for a visa, etc. Each application form includes various pre-defined fields such as “Applicant Name”, “Father's Name”, “Age”, “Nationality”, “Gender”, “Photo”, or the like. These pre-defined fields are filled-out by an applicant. The application form may be filled out online by the applicant via an online portal. But the application form may be filled offline by the applicant via pen, pencil, etc. and such filled-out application form is referred to as hand-written application form.

The term “filled-out content” refers to details filled-out by the applicant corresponding to various pre-defined fields in the application forms. For example, if the pre-defined field in the application form is “NAME”, then, “SAM” filled-out by the applicant represents the filled-out content. If the pre-defined field in the application form is photo of the applicant, then a photo pasted by the applicant on the application form is the filled-out content.

The “filled-out application form” is the one that includes filled-out content corresponding to pre-defined fields.

The term “verification documents” refer to any pre-verified documents issued to the applicant by various governing bodies such as government agencies, education boards, universities, bank agencies, or the like. Various examples of the verification documents may be driving license, birth certificate, passport, mark sheets, passing certificates, etc. The verification documents include various pre-defined fields such as “Name”, “Date of Birth”, “Address”, etc., and pre-verified content corresponding to the pre-defined fields. For example, the pre-verified content “SAM” corresponds to the pre-defined field “NAME”. Further, the verification documents required to validate the application forms, and these may vary based on the type of application form. For example, if the application form is a bank form, then the verification documents may be identity proof such as PAN card, address proof such as driving license, passport, and so on. But, if the application form is a college application form, then the verification documents may include an address proof such as a passport, a mark sheet, a passing certificate, or the like.

The term “pre-defined markings” refer to boundary designed/configured on a platen of the multi-function device for placing the verification documents for scanning. For example, the driving license may be placed on the right top corner of the platen or the passport may be placed on the right bottom corner of the platen.

The term “validation” refers to verifying whether the content filled-out in the application form is correct.

The term “matching” refers to comparing the filled-out content of the application form against the pre-verified content of the verification documents. The matching is performed to check or validate the correctness of the filled-out content. To accomplish this, first, the content of the filled-out application form and the verification documents submitted by the user are analyzed and extracted, i.e., filled-out content and pre-defined fields are extracted from the filled-out application form, and pre-defined fields and pre-verified content are extracted from the scanned verification documents. Once extracted, the filled-out content of the application form is matched with the pre-verified details of the verification document, and accordingly, validation is performed. Here, the matching is performed based on the percentage match between the filled-out content and the pre-verified details of the verification document. The value of the percentage match can be set in advance, i.e., before verification of the application form. Further, the value of the percentage match can be set by a user/employee of the organization verifying the application form and it is set based on the organizational requirements. In one example, the value of percentage match can be set such that obvious mistakes made by the applicant and device errors can be accommodated. Exemplary obvious mistakes include spelling mistakes (for instance, an applicant fills his name as “Shawn Mendis” instead of “Shawn K Mendis” which is provided on the verification document). In such scenario, the value of the percentage match can be set to a low value, e.g., 50%, so that if the match percentage between the filled-out content and the pre-verified details is more than 50%, only then the match is considered successful and the particular entry (filled out content) can be considered valid. In another example, the value of the percentage match can be set to a high value, say 100%, so that even a slight difference in the filled-out content and the pre-verified detail can result in an incorrect match.

The term “applicant” refers to the one who fills-out the application forms.

The term “user” refers to the one who receives the application form from the applicant for further processing. The user may be an employee of an organization or may be a person indirectly associated with the organization. The user uses the multi-function device to validate application forms received from various applicants. In some cases, the user may be same as the applicant, alternatively, the user and applicant may be different people without deviating from the scope of the disclosure.

### Overview

The present disclosure provides methods and systems for automatically validating application forms against one or more verification documents, specifically, the methods and systems validate content of a filled-out application form against one or more corresponding verification documents. For example, if the application form is a bank form, it can be validated against corresponding verification documents such as a permanent account number (PAN) card, a voter card, a driving license, a passport, or a combination thereof. In another example, if the application form is a college admission form, it can be validated against corresponding verification documents such as a passing certificate, mark sheets, an identity proof such as PAN card, or the like. In operation, the systems and methods analyze a filled-out application form and the corresponding verification documents and compare filled-out content of the filled-out application form with pre-verified content included in the verification documents. Based on the comparison, the filled-out content of the filled-out application form is validated. Here, no manual effort is involved for validating the filled-out application forms and hence, the systems and methods facilitate faster and error-free approach.

### Exemplary Environment

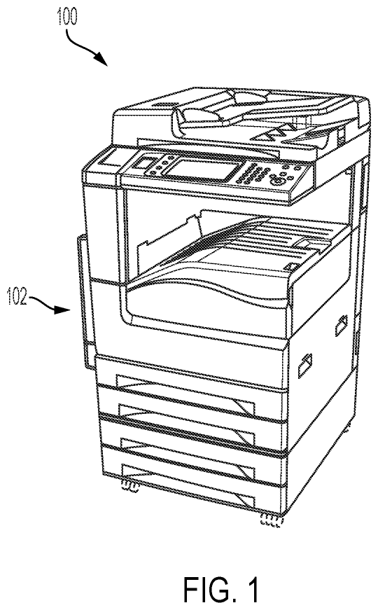

FIG. 1 shows an exemplary environment 100 in which various embodiments of the disclosure can be practiced. The environment 100 includes a multi-function device (MFD) 102 that provides one or more functionalities such as printing, scanning, imaging, copying, or the like. In context of the present disclosure, the multi-function device 102 provides validation feature to automatically validate filled-out application forms against one or more corresponding verification documents. Specifically, the multi-function device 102 validates content of a filled-out application form against one or more corresponding verification documents. The multi-function device 102 as shown is exemplary in nature but the environment 100 may include other equivalent devices such as scanner, multi-peripheral device, etc. for implementing the current disclosure. The multi-function device 102 may include various suitable components that are required to implement the current disclosure, although not shown.

The multi-function device 102 can be used in various organizations such as banks, colleges, schools, recruitment agencies, passport offices, visa office. These organizations require various application forms to be filled by various applicants for different purposes, e.g., opening a bank account, applying for a credit/debit card, applying for a passport/visa, getting admissions in schools/colleges, or the like. The application forms include various pre-defined fields such as “Applicant Name”, “Father's Name”, “Age”, “Address”, “Qualification”, “Gender”, etc., which are required to be filled-out by an applicant, and in order to the fill the application form, the applicants are required to fill their details corresponding to each pre-defined fields. For example, if “Name” is the pre-defined field, the applicant fills-out his name such as SMITH. In another example, if “Age” is the pre-defined field, the applicant fills-out his age such as 65. In further example, if the pre-defined field is “Gender”, the applicant fills-out his details such as Male. In additional example, if the pre-defined field is photo, the applicant provides his photo by pasting it. Like these pre-defined fields, the applicant is required to fill-out all pre-defined fields given in the application forms.

The application forms may vary based on organizational requirements. For example, the application forms for banks may be different from the application forms for colleges. In another example, the application forms for hospitals may be different from the application forms for passport offices, and so on. Further, the application forms may vary based on requirements within an organization. For example, the application form for applying loan may vary from the application form for opening a bank account. As another example, the application form for taking admission in college may vary from the application form for fee reimbursements. Accordingly, the pre-defined fields in each application form may vary based on type of form and/or organization. Further, the application form may be a multi-page document or a single page document and may include any number of pre-defined fields without limiting the scope of disclosure.

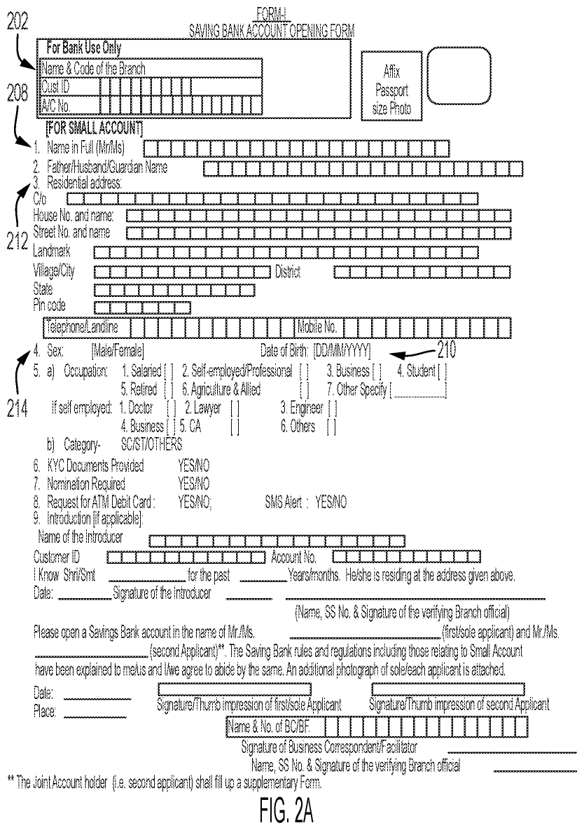

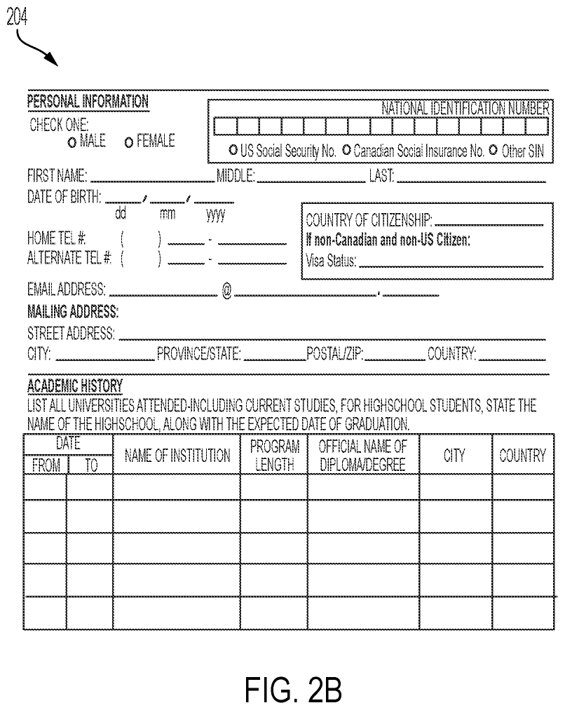

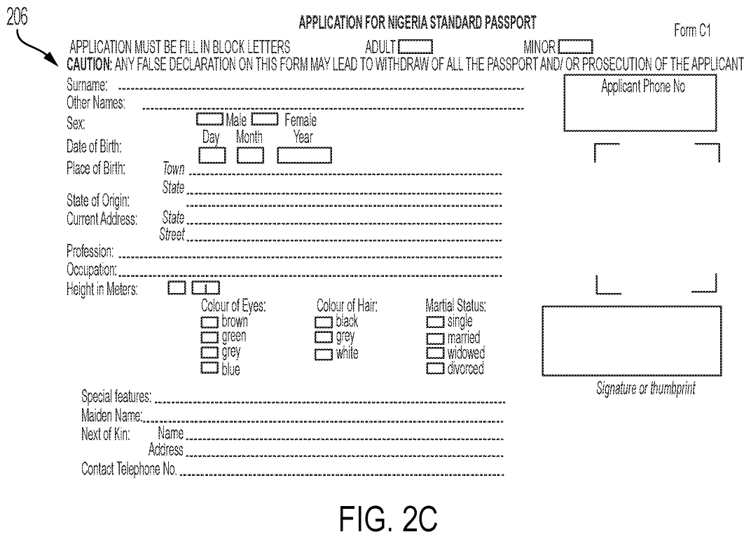

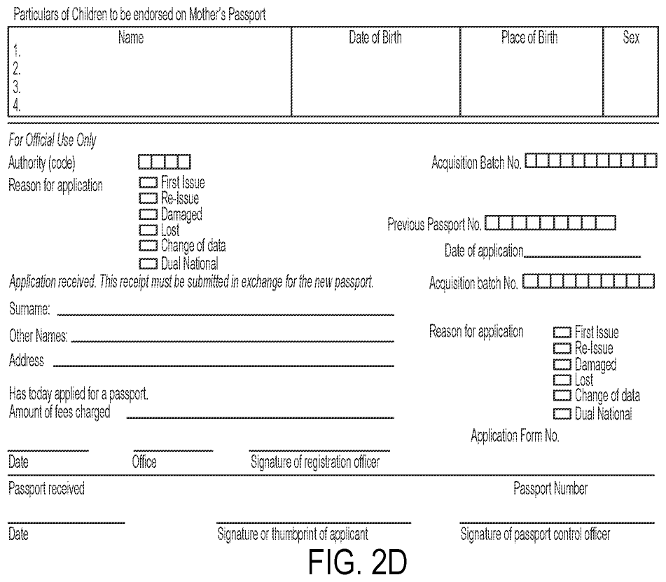

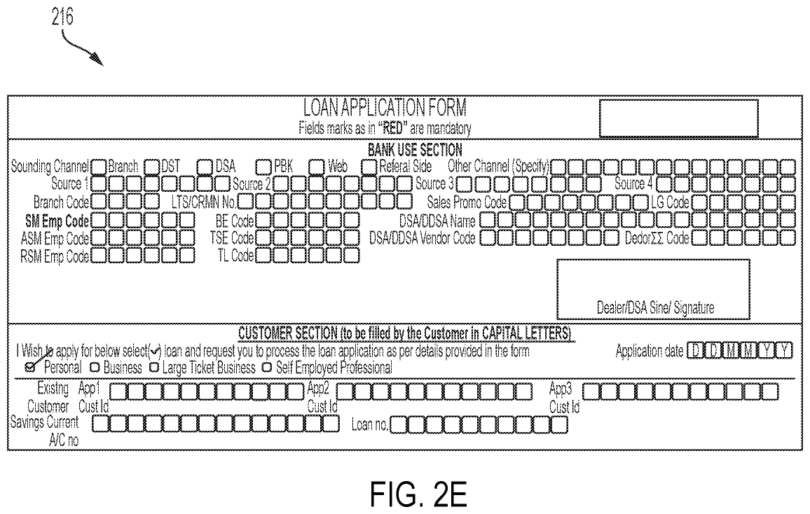

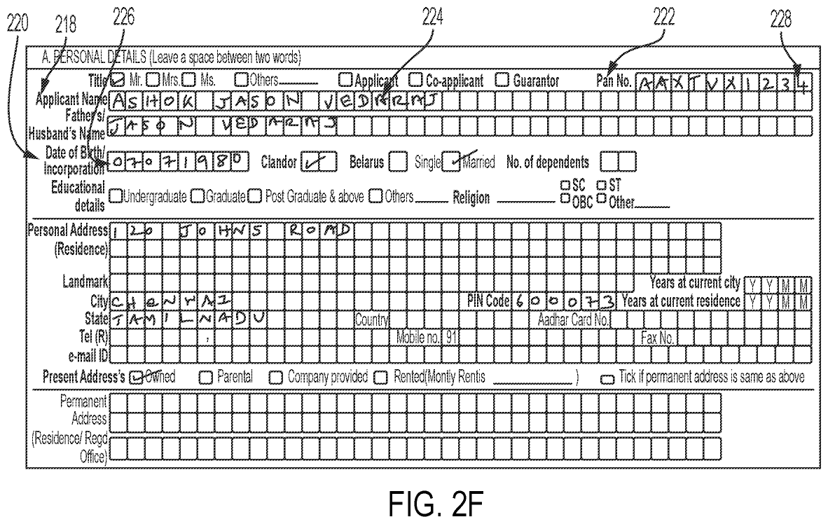

Few exemplary snapshots of application forms are shown in FIGS. 2A, 2B, 2C-2D, 2E-2F as 202, 204, 206 and 216, respectively. For example, FIG. 2A shows a bank form 202 for opening an account, FIG. 2B represents an application form 204 for students, FIGS. 2C-2D represent an application form 206 for a passport. Each application form 202, 204, 206 and 216 includes various pre-defined fields. As an example, the bank form 202 as in FIG. 2A includes pre-defined fields such as “Name” 208, “Date of Birth” 210, “Residential Address” 212, “Sex” 214, and so on. Each pre-defined field is filled-out by an applicant in order to fill out the application form. Similar to the bank form 202 shown in FIG. 2A, other application forms such as 204, 206 include pre-defined fields (although not labelled) which are filled-out by the applicant or anyone on behalf of the applicant.

FIGS. 2E-2F illustrate a snapshot of a filled-out loan form 216. As illustrated, the loan form 216 includes pre-defined fields “Applicant Name” labeled as 218, “Date of Birth” labeled as 220, “PAN No.” labeled as 222, and so on (as can be clearly seen in FIG. 2E). Further, the loan form 216 includes content filled-out against various pre-defined fields by an applicant. For instance, “Ashok Jason Vedaraj” labeled as 224 is filled against the pre-defined field 218, “07 07 1980” labeled as 226 is filled against the pre-defined field 220, “AAXTVX1234” labeled as 228 is filled against the pre-defined field 222, and so on (as can be clearly seen in FIG. 2F). Moreover, each pre-defined field may have a pre-defined format. As an example, the pre-defined field “Name” 208 may be alphabetic, the pre-defined field “Date of Birth” 210 may be numeric, and so on.

The verification documents are pre-verified documents issued to the applicant by various governing bodies such as government agencies, education boards, banks, or the like. Various examples of the verification documents may be driving license, birth certificate, passport, passing certificate, etc. The verification documents include various pre-defined fields such as “NAME”, “Date of Birth”, “Address”, etc. The verification documents include pre-verified content provided corresponding to the pre-defined fields. For example, pre-verified content “SAM” corresponds to the pre-defined field “NAME”. Further, the verification documents are required to validate the application form, and these may vary based on the organization. For example, the verification documents required to validate an account opening form may be, PAN card, Driving license, etc. In another example, the verification documents required to validate an admission form for a college may include a passport, a passing certificate, etc. Furthermore, the verification documents required to validate the application form may vary based on requirements within an organization. For example, the verification documents required to validate a debit card form may include, PAN card, Driving license, etc. In another example, the verification documents required to validate a loan form may include a salary slip, passport, etc. The verification documents may be a single page document or a multi-page document. The verification documents may be originals or include e-copy of the originals depending upon the requirements of the application form or the concerned organization.

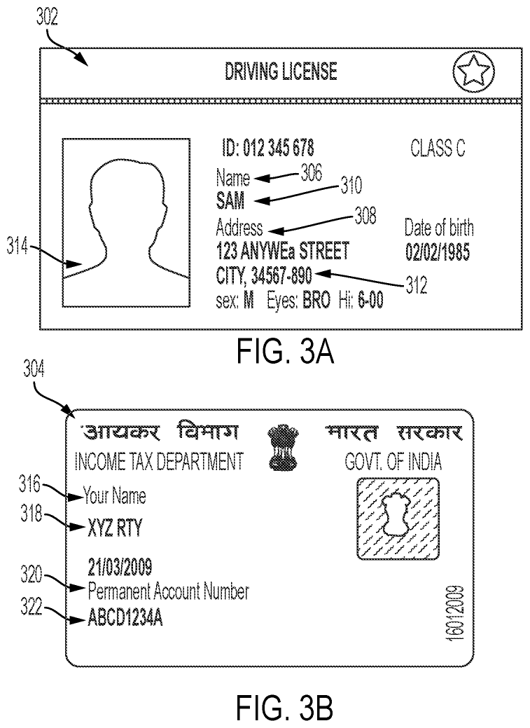

Few exemplary snapshots of the verification documents are shown in FIGS. 3A and 3B as 302 and 304. The verification documents may be driving license 302 and a PAN card 304 as shown in FIGS. 3A and 3B, respectively. Each verification document includes various pre-defined fields and corresponding pre-verified content. For example, the driving license 302 as shown in FIG. 3A includes pre-defined field “Name” 306 and corresponding pre-verified content as “SAM” 310. Similarly, the pre-defined field is “Address” 308 and corresponding pre-verified content is “123 ANYWEa STREET CITY, 34567-890”, marked as 312. The driving license 302 includes an actual photo of the applicant marked as 314 corresponding to the pre-defined field photo, although not shown here. Further, the snapshot of PAN card 304 is shown in FIG. 3B, where the pre-defined field name is “Your Name” 316 and corresponding pre-verified content is “XYZRTY” 318. Similarly, the PAN 304 further includes another pre-defined field “Permanent Account Number” 320 and corresponding pre-verified content is “ABCD1234A”, marked as 322.

In implementation, an applicant fills-out an application form, which is then submitted at the multi-function device 102 for validation. To this end, the applicant is required to submit his verification documents at pre-defined markings on the multi-function device 102. Once submitted, the multi-function device 102 starts processing the filled-out application form and the verification documents. For example, the multi-function device 102 scans the filled-out application form and then scans the verification documents. In another example, the multi-function device 102 scans the verification documents and then scans the filled-out application form. Upon successful scanning, the filled-out content of the application form is matched with pre-verified content of the verification documents, where filled-out content of the application form is matched with pre-verified content of each verification document. Based on successfully matching for all pre-defined fields of the filled-out application form, validation of the filled-out application form is complete.

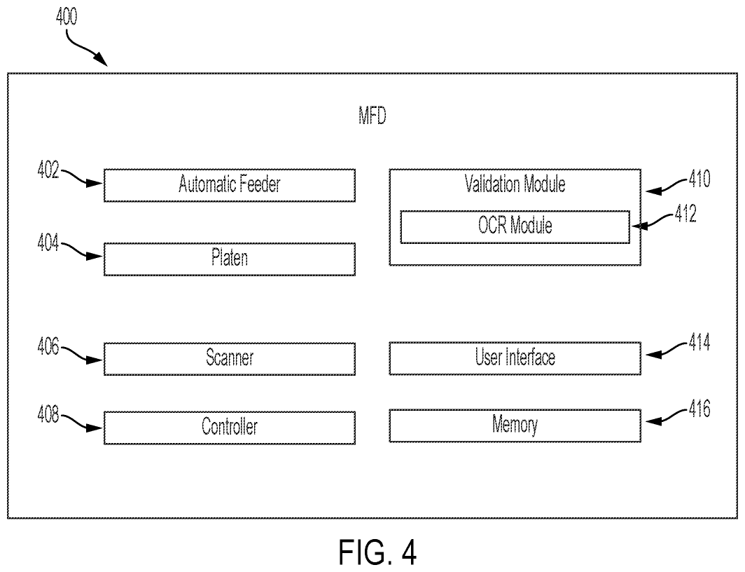

FIG. 4 illustrates a block diagram of a multi-function device 400 for implementing the current disclosure. As illustrated, the multi-function device 400 includes an automatic feeder 402, a platen 404, a scanner 406, a controller 408, a validation module 410 including an Optical Character Recognition (OCR) module 412, a user interface 414, and a memory 416. The OCR module 412 may be a part of the validation module 410 or may be separate from the validation module 410. The components 402-416 are connected to each other via a conventional bus or a later developed protocol. And the components 402-416 communicate with each other for performing various functions of the present disclosure. The multi-function device 400 may further include additional component(s) as required to implement the present disclosure. The multi-function device 400 may perform functions and operations similar to the multi-function device 102 of FIG. 1.

Initially, an applicant fills-out an application form, which may be a multi-page form. But the application form may be a single page form. Along with the filled-out application form, the applicant provides one or more required verification documents corresponding to the filled-out application form. The filled-out application form and the required verification document may be submitted to a user or directly at the multi-function device 400 for further processing. For example, the applicant may submit the filled-out application form and the required verification documents to the user and the user may further submit these at the multi-function device 400. In another example, the applicant may directly submit the filled-out application form and the required verification documents at the multi-function device 400.

In operation, the user places the application form on the automatic feeder 402 such as a duplex automatic document handler (DADH), whereas the verification documents are placed on the platen 404. The verification documents are placed on pre-defined markings on the platen 404. The pre-defined markings are pre-set based on a requirement of an organization.

In detail, the platen 404 includes various pre-defined markings on which the verification documents are required to be placed. The various pre-defined markings may be present at various locations on the platen 404, for example, top right corner, top left corner, bottom right corner, bottom left corner, and so on. Here, the pre-defined markings define a boundary/area within which the verifications documents are required to be placed. For instance, the driving license may be placed on the top right corner and the passport may be placed on the bottom right corner of the platen 404. Each pre-defined marking may be for specific verification document. For example, one pre-defined marking may be for a verification document such as PAN card, whereas the other pre-defined marking may be for a verification document such as Voter card.

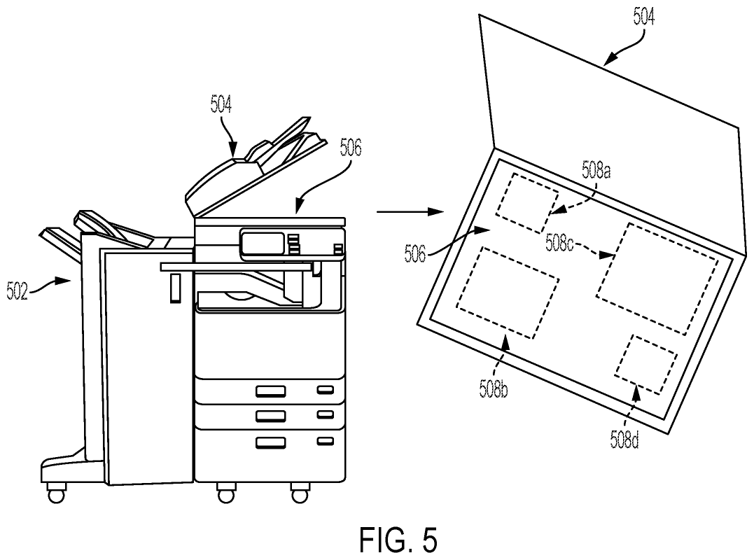

For better clarity, few exemplary pre-defined markings are shown in FIG. 5. Here, FIG. 5 shows a multi-function device 502 having an automatic feeder 504 and a platen 506 with one or more pre-defined markings, e.g., 508a, 508b, 508c, 508d, for placing the verification documents. For example, the pre-defined marking 508a is specifically for permanent account number card (PAN) card, the pre-defined marking 508b is for passport, the pre-defined marking 508c is for voter card, the pre-defined marking 508d is for birth certificate, etc. The pre-defined markings e.g., 508a, 508b, 508c, 508d defines the boundary in which the verification documents are required to be placed for scanning. The dimensions of the pre-defined marking are defined/set based on the type of verification document. For example, if the verification document such as the PAN card is of size 3 cm×4 cm, then the dimensions or the pre-defined marking may be approximately 3.1 cm×4.1 cm such that the PAN card fits appropriately with the pre-defined marking for scanning. The pre-defined markings are defined on the platen 506 based on the type of the verification documents that are required to be scanned. And the verification documents vary based on organizational requirements. For example, if the organization is bank, where the required verification documents are PAN card and voter card, then the pre-defined markings may be of size 3 cm×4 cm and 5 cm×6 cm respectively. In another example, if the organization is a college, where the required verification documents may be a passing certificate and a passport, then dimensions of the pre-defined markings may be 7 cm×14 cm and 4 cm×4 cm respectively. The number of pre-defined markings shown on the platen 506 are exemplary in nature and the number of pre-defined markings, their dimensions, their shape, locations, etc. may vary based on various requirements and/or based on implementation of the present disclosure.

This way, the multi-function device 400 receives the filled-out application form and the verification documents at pre-defined markings on the platen 404. After receiving the filled-out application form on the automatic feeder 402 and the verification documents on pre-defined markings on the platen 404, the user initiates scanning for validation. In one example, the user may initiate the scanning by selecting a pre-defined option such as “validation option” (although not shown) presented on the user interface 414.

Upon initiation of scanning, the controller 408 triggers or communicates with the scanner 406 to scan the application form and the verification documents in a pre-defined order. For example, the application form is scanned first and then the verification documents are scanned. In another example, the verification documents are scanned first and then the application form is scanned.

The scanner 406 scans the filled-out application form first and generates the scanned filled-out application form. The scanned filled-out application form may be output in any desired format such as PDF, PNG, etc. Then, the scanner 406 scans the verification documents as placed on the pre-defined markings on the platen 404 and generates the corresponding scanned verification documents. Similarly, the scanned verification documents may be output in any desired format such as PDF, PNG, etc. Thereafter, the controller 408 sends the scanned filled-out application form and the scanned verification documents to the validation module 410 for further processing.

The validation module 410 receives the scanned filled-out application form and the scanned verification documents. The validation module 410 triggers the OCR module 412 to processes these scanned filled-out application form and required scanned verification documents. The OCR module 412 analyzes the scanned filled-out application form and the scanned verification documents to extract content from the scanned filled-out application form and the scanned verification documents. Specifically, the OCR module 412 extracts pre-defined fields and filled-out content from the scanned filled-out application form. Like this, the OCR module 412 extracts pre-defined fields and pre-verified content from the scanned verification documents. In addition to this, the OCR module 412 extracts other details given on the scanned filled-out application form, e.g., organization name, form name, form ID, form type, form reference number, etc. Similarly, the OCR module 412 extracts other details provided on the verification documents, e.g., type of verification document, i.e., whether the verification document is a driving license, a PAN card, passport, or the like, expiration date of the verification document, etc. Post successful extraction, the OCR module 412 communicates and sends the extracted content of the scanned filled-out application form and the extracted content of the scanned verification documents to the validation module 410.

The validation module 410 receives the extracted content (pre-defined fields, filled-out content and other details) of the scanned filled-out application form and the extracted content (pre-defined fields, pre-verified content and other details) of the scanned verification documents. Upon receiving, the validation module 410 segregates the pre-defined fields and the filled-out content of the scanned filled-out application form. For example, the validation module 410 may perform segregation using template matching method, where the filled-out application form is placed on a blank application form. After successful segregation, the validation module 410 first identifies the application form based on the other details on the filled-out application form such as form name, form id, etc. Then, the validation module 410 recognizes the pre-defined fields of the filled-out application form. For example, the validation module 410 recognizes and understands that “Name of the applicant” refers to name. In another example, the validation module 410 recognizes and understands that “Age” may be related to Date of Birth and so on.

Similarly, the validation module 410 segregates the pre-defined fields and the pre-verified content of the scanned verification documents. After successful segregation, the validation module 410, identifies the verification documents based on the other details given such as name, ID, given on these documents, etc. Then, the validation module 410 recognizes the pre-defined fields of the verification documents. For example, the validation module 410 recognizes and understands that “Name” refers to name. In another example, the validation module 410 recognizes and understands that “Date of Birth” may be related to Age. In further example, the validation module 410 recognizes and understands that pre-defined field “Sex” may be related to Gender.

Based on the above, the validation module 410 compares extracted content of the filled-out scanned application form i.e., the pre-defined fields and the filled-out content with the extracted content of the scanned verification document i.e., the pre-defined fields and the pre-verified content. To this end, the validation module 410 first identifies a correlation between the pre-defined fields and the pre-verified details, i.e., the validation module 410 identifies which pre-defined fields of the scanned filled-out application form need to be compared with which pre-verified details of the scanned verification documents. The validation module 410 can be pre-configured to identify the correlation. In one example, the validation module 410 is trained using various templates of the different types of the application form and the verification documents to identify the correlation between the pre-defined fields and the pre-verified details. In another example, while submitting the application form and the verification documents for validation, the user selects the template of the application form and the verification documents, and the validation module 410 is trained such that the validation module 410 identifies the correlation between the pre-defined fields and the pre-verified details. Once identified, the validation module 410 validates the filled-out content of the application form.

In detail implementation, the validation module 410 performs validation of the filled-out application form by matching the extracted filled-out content corresponding to pre-defined fields of the scanned filled-out application form with the extracted pre-verified content corresponding to pre-defined fields of the verification documents. For example, the validation module 410 matches the filled-out content of the application form, for example, SAM, corresponding to the pre-defined field “Applicant Name”, with the pre-verified content of the verification documents such as “SAM” corresponding to the pre-defined field “NAME”. If matches, the validation of the filled-out content corresponding to the pre-defined field “Applicant Name” is successful. In case of no match, the validation module 410 considers the mismatch as error and highlights that particular pre-defined field in the scanned filled-out application form. Here, the matching is performed based on an analysis of the percentage match between the filled-out content and the pre-verified details of the verification document. The value of the percentage match can be set in advance, i.e., before verification of the application form. Further, the value of the percentage match can be set by a user/employee of the organization verifying the application form. The value of the percentage match is set based on the requirement of the concerned organization, i.e., the organization associated with the application form. In one example, the value of percentage match can be set such that mistakes made by applicants or device errors can be accommodated. Exemplary applicant mistakes include spelling mistakes (for instance applicant fills his name as “Shawn Mendis” instead of “Shawn K Mendis” which is provided on the verification document). In such scenario, the value of the percentage match can be set to a low value, e.g., 50%, so that if the match percentage between the filled-out content and the pre-verified details is more than 50%, only then the match is considered successful and the particular entry (filled out content) can be considered valid. In another example, the value of the percentage match can be set to a high value, say 100%, so that even a slight difference in the filled-out content and the pre-verified detail may result in an incorrect match. This way, the matching is performed. Further, the validation module 410 highlights the mismatch entries in a particular color, for example. The validation module 410 may further notify the user, the applicant, or other relevant stakeholders of the organization. The validation module 410 may notify them via email, phone, text message, or the like. Similar to the pre-defined field “Name”, the validation module 410 validates all pre-defined fields of the scanned filled-out application form against the verification documents till completion. This way, the validation module 410 completes the validation of the filled-out application form.

The validation module 410 may be pre-configured or configured in way such that the validation module 410 validates the filled-out application form against the verification documents. For example, the validation module 410 is trained to recognize blank application forms, filled-out application forms, verification documents, partially filled-out application forms, or the like. Here, the validation module 410 understands and recognizes each application form, its types, various fields, filled-out content and so on. Similarly, the validation module 410 understands and recognizes various verification documents, types, and pre-verified content. Based on the configuration, the validation module 410 identifies which pre-defined field of the filled-out application form requires to be compared with which pre-defined field of a verification document. And it identifies which pre-defined field of the filled-out application form is required to be compared with a pre-defined field of which verification document and so on. Moreover, the validation module 410 is pre-configured to determine whether all the pre-defined fields of the application form are required to be validated or only a few pre-defined fields of the application form are required to be validated. And in case only a few pre-defined fields of the application form are required to be validated, then the form validation module 410 is also pre-configured to identify the pre-defined fields, i.e., specific fields that are required to be validated. These are few examples, the validation module 410 can be configured in desired way to implement the present disclosure.

The application forms as discussed above are hand-written application forms, but the disclosure may be implemented for the application forms that are filled-out online. In such cases, after the application form is submitted via an online portal, the applicant receives a unique reference ID or reference number, which is to be submitted at the multi-function device 400 for further processing. In operation, the controller 408 prompts the user to input the reference ID or the reference number of the application form. The user then provides the reference ID or number via the user interface 414. Once provided, the controller 408 retrieves the filled-out application form from a server associated with the online portal. Once retrieved, the controller 408, requests the user to provide one or more required verification documents on pre-defined markings of the platen 404. Once provided, the controller 408 triggers the scanner 406 to scan the verification documents. Thereafter, the scanner 406 scans the verification documents and generates the corresponding scanned verification documents. Once generated, the controller 408 shares the retrieved filled-out application form and the scanned verification documents with the validation module 410 for further processing. Thereafter, the validation module 410 then validates the filled-out application form against the verification documents in the same way as discussed above.

Continuing with FIG. 4 description, the user interface 414 displays various messages, instructions to the user and/or the applicant. For example, the user interface may show a message, “please place your verification documents properly”. In another example, the user interface 414 may display an instruction “move your document to the right corner”. In further example, the user interface 414 displays one or more errors in the scanned filled-out application form. The user interface 414 further receives various inputs from the user or the applicant required for implementing the current disclosure.

The memory 416 stores all relevant information required for implementing the current disclosure. For example, the memory 416 may store filled-out scanned application forms, scanned verification documents, extracted filled-out content, extracted pre-verified content in any desired format required for processing. The memory 416 may store various templates of application forms i.e., blank application forms and filled-out application forms, verification documents and so on. Any details stored in the memory 416 may be retrieved by the validation module 410 or other components for implementing the current disclosure.

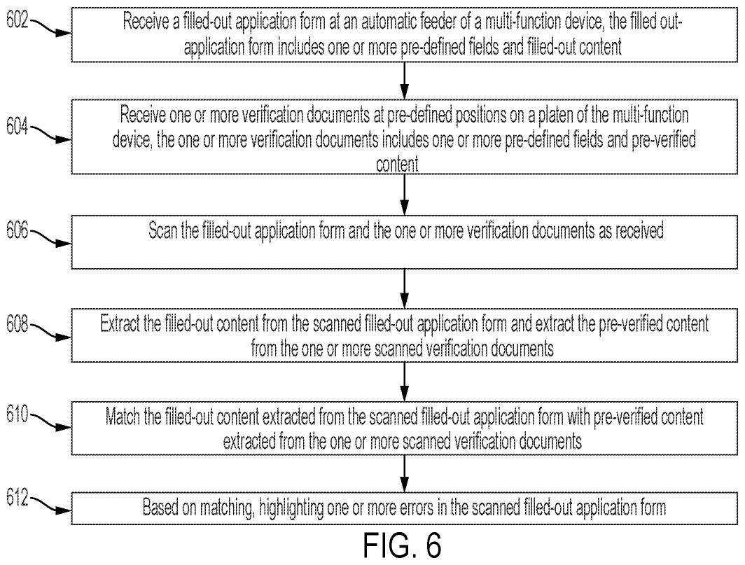

FIG. 6 is a method flowchart for automatically validating application forms against corresponding one or more verification documents. The method may be implemented at a multi-function device, such as the multi-function device 102 of FIG. 1, the multi-function device 400 of FIG. 4, or the multi-function device 502 of FIG. 5. However, the method can be implemented at any equivalent device with scanning, validating application forms functionalities, and so on.

The method begins when an applicant fills-out an application form and provides it for processing such as validation. Along with the filled-out application form, the applicant provides one or more corresponding verification documents. Once provided, the filled-out application form and the corresponding verification documents are submitted at the multi-function device either by the applicant or by a user. For easy discussion, it is considered that the filled-out application form and the corresponding one or more verification documents are submitted at the multi-function device by the user, i.e., an employee of an organization. Specifically, the filled-out application form is placed at an automatic feeder, e.g., duplex automatic document handler (DADH) of the multi-function device, while the corresponding verification documents are placed on pre-defined markings. For instance, the driving license may be placed on the top right corner of the platen, whereas the PAN card may be placed on the top left corner of the platen. In another example, the voter card may be placed on a centre portion of the platen.

Once submitted, at block 602, the filled-out application form is received at the multi-function device, i.e., at the automatic feeder for scanning. The filled-out application form includes one or more pre-defined fields and filled-out content. Along with the filled-out application form, the corresponding verification documents are received at the multi-function device, i.e., at the pre-defined markings on the platen, at block 604. The verification documents include one or more pre-defined fields and pre-verified content.

Upon receiving, the user initiates scanning, for example, by pressing a scan button on the multi-function device. Then, at block 606, the filled-out application form and the one or more verification documents as received are scanned. For example, the filled-out application form is scanned first and then the one or more verification documents are scanned. In another example, the one or more verification documents are scanned and then the filled-out application form is scanned. Upon successful scanning, a scanned filled-out application form is generated corresponding to the filled-out application form, in any desired format such as PDF, PNG, or the like. Similarly, scanned verification documents are generated corresponding to the one or more verification documents, in any desired format such as PDF, PNG, or the like. For example, if there are two verification documents such as a PAN card and a voter card, then two scanned verification documents are generated, one for the PAN card and the second for the voter card. Post generation, the scanned filled-out application form and the scanned verification documents are processed further.

The scanned filled-out application form and the scanned verification documents are analyzed to extract corresponding scanned content. Specifically, at 608, filled-out content and pre-defined fields from the scanned filled-out application form are extracted; and pre-defined fields and pre-verified content from the scanned verification documents are extracted. After extraction, correspondence between the pre-defined fields of the scanned filled-out application form and the pre-defined fields of the verification documents is determined. For example, it is identified which pre-defined field of the filled-out application form is to be compared with which pre-defined field of a verification document. Once correspondence between the pre-defined fields of the scanned filled-out application forms and pre-defined fields of each verification document is established, the method proceeds further.

At block 610, the filled-out content of the application form is matched with the pre-verified content of the verification document. Specifically, the filled-out content corresponding to a particular pre-defined field of the scanned filled-out application form is matched with the pre-verified content corresponding to that pre-defined field of the verification documents. For example, if the filled-out content of the application form corresponding to a pre-defined field “Applicant name”, is say, SAM, then SAM is matched with a pre-verified content, i.e., SAM corresponding to the pre-defined field “NAME” of the verification documents. Similarly, remaining filled-out content extracted from the scanned filled-out application form is compared with the pre-verified content of each verification document.

Based on the matching, at 612, one or more errors or unmatched filled-out content are highlighted in the scanned filled-out application form. For example, if the whole filled-out content matches with the pre-verified content, then the method marks the filled-out application form as successfully verified. Otherwise, the one or more errors are highlighted in the scanned filled-out application form. Here, the unmatched filled-out content along with corresponding pre-defined field is highlighted in the scanned filled-out application form. The one or more errors are displayed to the user via the user interface of the multi-function device. In some implementations, the user may be notified about the errors via email, text, or a combination thereof. In other implementations, a notification may be generated sent to the applicant, owner of the organization, branch head, or other relevant stakeholders. The one or more unmatched content is highlighted in the scanned filled-out application form for further action. For example, the applicant can make corrections based on the highlights in the scanned filled-out application form via the user interface. Here, the user interface including the editable scanned filled-out application form is displayed, the applicant can see the highlighted filled-out content and make the required corrections at the multi-function device itself. In another example, officials of the organization may be informed or notified about the unmatched filled-out content in the scanned filled-out application form.

Here, OCR operation is performed both on the scanned verification documents (such as PAN Card or Driving License) and the scanned filled-out application form for matching purpose at later stages. For example, the section of text/details that need to be OCRed in the filled-out application form and verification documents can be configured by respective office such as Bank, Insurance company, or the like. The configuration is one-time process and can be done by any office person or an admin user. The configuration here refers to defining/mapping which field of the filled-out application form need to match with particular field in the verification documents. For example, “Name” in PAN can be mapped with a section called “Name” in the filled-out application form. In another example, “Address” from Voter ID can be mapped with “Residential Address” section in the filled-out application form.

The method or the blocks 602, 604, 606, 608, 610 and 612, can be implemented in the form of a non-transitory storage medium.

The pre-defined markings are defined in context of placing the verification documents at the multi-function device for processing and the user or the applicant is required to place the verification documents based on the pre-defined markings as discussed above. The pre-defined order is in context of scanning the filled-out application form and the verification documents and they can be scanned in any order as discussed above without limiting the scope of disclosure.

The disclosure can be implemented for any organization such as banks, hospitals, schools, passport offices, etc. For example, a multi-function device such as 102 can be placed in an organization where employees of the organization can collect application forms along with corresponding verification documents from various applicants and use the multi-function device for validating the filled-out application forms. In another example, applicants can directly use the multi-function device for validating the application forms. In some implementations, the disclosure can be implemented for individual users. For example, a multi-function device such as 102 can be placed in a home, where a user can use the multi-function device 102 each time before submitting the filled-out application form to organization. This ensures accuracy of the filled-out application form in advance and hence saves the overall time of the user at the time when he visits the required organization such as a bank. These are few examples, but the disclosure can be implemented by any organization, individual users, etc., without limiting the scope of the disclosure.

The present disclosure discloses methods and systems for automatically validating filled-out application forms against one or more verification documents. As the disclosure facilitates automatic validation of the application forms, hence, no or minimal effort from a user (such as an employee or applicant) is required. The methods and systems further reduce overall processing time for validating the application forms, ensure accuracy, and follow an unbiased approach. Due to the overall reduction in processing time, applicants (i.e., customers) are not required to face a long queue waiting issue, hence the overall customer experience is enhanced.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, identifying, scanning, segregating, sending, matching, highlighting, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for validating a filled-out application form against one or more verification documents, the method comprising:
receiving the filled-out application form at an automatic feeder of a multi-function device, the filled-out application form comprising one or more pre-defined fields and filled-out content;
receiving one or more verification documents at one or more locations on a platen of the multi-function device, the platen having a plurality of pre-defined markings at a plurality of locations on the platen for receiving the one or more verification documents, each pre-defined marking is specific to a particular verification document, each pre-defined marking defines a boundary within which the corresponding verification document is to be placed for scanning, each pre-defined marking has set dimensions based on the corresponding verification document, the one or more verification documents comprising one or more pre-defined fields and pre-verified content;
scanning the filled-out application form and the one or more verification documents as received at the multi-function device;
extracting the filled-out content from the scanned filled-out application form and extracting the pre-verified content from the one or more scanned verification documents;
matching the filled-out content extracted from the scanned filled-out application form with the pre-verified content extracted from the one or more scanned verification documents; and
based on the matching, highlighting unmatched filled-out content in the scanned filled-out application form for further action.

2. The method of claim 1, further comprising identifying the application form type.

3. The method of claim 1, further comprising receiving the one or more verification documents based on the application form.

4. The method of claim 1, further comprising:
segregating the one or more pre-defined fields and filled-out content from the scanned filled-out application form;
segregating the one or more pre-defined fields and pre-verified content from the one or more scanned verification documents.

5. The method of claim 1, further comprising identifying one or more pre-defined fields of the scanned filled-out application form to be matched with one or more pre-defined fields of the one or more scanned verification documents.

6. The method of claim 5, further comprising matching filled-out content corresponding to one or more identified pre-defined fields of the scanned filled-out application form with pre-verified content corresponding to the one or more identified pre-defined fields of the one or more scanned verification documents.

7. The method of claim 1, further comprising displaying the highlighted unmatched filled-out content via a user interface of the multi-function device.

8. The method of claim 1, further comprising generating a notification based on the highlighted unmatched filled-out content.

9. The method of claim 1 is implemented in the form of a non-transitory storage medium.

10. A multi-function device comprising:
an automatic feeder for receiving a filled-out application form;
a platen having a plurality of pre-defined markings at a plurality of locations on the platen for receiving one or more verification documents, each pre-defined marking is specific to a particular verification document, each pre-defined marking defines a boundary within which the corresponding verification document is to be placed for scanning, and each pre-defined marking has set dimensions based on the corresponding verification document;
a controller for requesting the user to provide a particular pre-defined verification document on a particular pre-defined marking on the platen of the multi-function device;
a scanner for scanning the filled-out application form and the one or more verification documents, wherein the filled-out application form comprises one or more pre-defined fields and filled-out content, each verification document comprises one or more pre-defined fields and pre-verified content;
a validation module for matching the filled-out content from the scanned filled-out application form with the pre-verified content of each scanned verification document; and
a user interface for displaying unmatched filled-out content in the scanned filled-out application form.

11. The multi-function device of claim 10, wherein the validation module is configured to generate a notification based on the unmatched filled-out content.

12. The multi-function device of claim 10, wherein the validation module is configured to highlight the unmatched filled-out content in the scanned filled-out application form.

13. A multi-function device for validating content of a filled-out application form against one or more verification documents, the multi-function device comprising:
an automatic feeder for receiving a filled-out application form, the filled-out application form comprising one or more pre-defined fields and filled-out content;
a platen having a plurality of pre-defined markings at a plurality of locations on the platen for receiving one or more verification documents, each pre-defined marking is specific to a particular verification document, each pre-defined marking defines a boundary within which the corresponding verification document is to be placed for scanning, each pre-defined marking has set dimensions based on the corresponding verification document, and each verification document comprises one or more pre-defined fields and pre-verified content;
a scanner for scanning the filled-out application form and the one or more verification documents;
a validation module for:
extracting the filled-out content from the scanned filled-out application form and extracting the pre-verified content from the one or more scanned verification documents;
matching the filled-out content extracted from the scanned filled-out application form with pre-verified content extracted from the one or more scanned verification documents; and
based on matching, highlighting unmatched filled-out content in the scanned filled-out application form; and
a user interface for displaying the highlighted unmatched filled-out content in the scanned filled-out application form.

14. The multi-function device of claim 13, wherein the validation module identifies the application form type.

15. The multi-function device of claim 13, wherein the one or more verification documents are received based on the application form.

16. The multi-function device of claim 13, wherein the validation module:
segregates the one or more pre-defined fields and filled-out content from the scanned filled-out application form;
segregates the one or more pre-defined fields and pre-verified content from the one or more scanned verification documents.

17. The multi-function device of claim 13, wherein the validation module identifies one or more pre-defined fields of the scanned filled-out application form to be matched with one or more pre-defined fields of the one or more scanned verification documents.

18. The multi-function device of claim 17, wherein the validation module matches the filled-out content corresponding to one or more identified pre-defined fields of the scanned filled-out application form with pre-verified content corresponding to the one or more identified pre-defined fields of the one or more scanned verification documents.

19. The multi-function device of claim 13, wherein the validation module identifies one or more errors based on the unmatched filled-out content.

20. The multi-function device of claim 19, wherein the validation module generates a notification based on the one or more errors.
